(19) United States
(12) Patent Application Publication
(10) Pub. No.: US 2016/0178136 A1
(43) Pub. Date: Jun. 23, 2016

(54) LED Fluorescent Tube

(71) Applicant: FORMOSA OPTRONICS CO., LTD., New Taipei City (TW)

(72) Inventor: TSAN-JUNG CHEN, New Taipei City (TW)

(21) Appl. No.: 14/952,962

(22) Filed: Nov. 26, 2015

(30) Foreign Application Priority Data
Dec. 17, 2014 (TW) 103222320

(51) Int. Cl. F21K 99/00; F21V 3/04; F21V 3/02; F21V 23/00; F21V 7/00

(52) U.S. Cl. CPC F21K 9/175; F21V 23/006; F21V 7/00; F21V 3/02; F21V 3/0409; F21Y 2103/003

(57) ABSTRACT

The present invention provides an LED fluorescent tube. In this LED fluorescent tube, at least one flexible PCB is particularly used for carrying the LED driving unit, wherein the flexible PCB can be accommodated in end caps of the LED fluorescent tube by a bend form. Thus, because the size of the end caps is minimized due to such arrangement, the illumination range of the LED fluorescent tube is therefore increased. Moreover, by the use of the flexible PCB, the inner structure of the end cap does be simplified, so as to make the production difficulty and manufacturing cost of the LED fluorescent tube be largely reduced.

### BACKGROUND OF THE INVENTION

1. Field of the Invention

The present invention relates to the technology field of LED lighting, and more particularly to an LED fluorescent tube.

2. Description of the Prior Art

Recently, light-emitting diodes (LEDs) have been broadly applied to the illumination devices used in human life. Please refer to FIG. 1, which illustrates a stereo view of a traditional LED lighting tube. As shown in FIG. 1, the traditional LED lighting tube 1′ consists of: a tube-shaped cover 11′, a substrate 12′, a PCB 13′, a plurality of LED chips 14′, and two end caps 15′, wherein the substrate 12′ is disposed in the tube-shaped cover 11′ and the PCB 13′ installed with the LED chips 14′ is disposed on the substrate 12′. After connecting the electrical wires 151′ of the end caps 15′ with the PCB 13′, the end caps 15′ are covered the two openings of the tube-shaped cover 11′, such that the supplied power can be transmitted from the electrical wires 151′ to the PCB 13′ by electrically connecting by an external power source to the electrical terminals 152′ of the en caps 15′.

Although the traditional LED lighting tube 1′ includes an advantage of simple structure, the traditional LED lighting tube 1′ reveals a primary drawback in practical application. From FIG. 1, it can find that the traditional LED lighting tube 1′ does not include any power modules or LED driving units in structure. So that, when applying the traditional LED lighting tube 1′ as the illumination devices, an additional power module must be connected to the traditional LED lighting tube 1′ when installing the traditional LED lighting tube 1′.

In view of the traditional LED lighting tube 1′ shown by FIG. 1 including the drawback of lacking power module in structure, an conventional LED lighting tube is therefore developed and proposed by manufacturers. Please refer to FIG. 2, which illustrates an exploded view of a conventional LED lighting tube. As shown in FIG. 2, the conventional LED lighting tube 1a consists of: an accommodating body 11a, a PCB 13a, a plurality of LED chips 14a, and two en caps 15a, wherein the accommodating body 11a comprises a PCB carrying portion 111a and a cover portion 112a, and the PCB 13a installed with the LED chips 14a is disposed on the PCB carrying portion 111a. Particularly, a power module 16a is disposed in the PCB carrying portion 111a of the accommodating body 11a.

Therefore, comparing the traditional LED lighting tube 1′ shown by FIG. 1 with the conventional LED lighting tube 1a shown by FIG. 2, it is clear that the conventional LED lighting tube 1a overcomes the drawback of the traditional LED lighting tube 1′ because of having power module 16a disposed in the PCB carrying portion 111a of the accommodating body 11a. However, when practically applying the conventional LED lighting tube 1a as the illumination devices in human life, the conventional LED lighting tube 1a reveals following shortcomings and drawbacks:

(1) Because the heat generated by the power module 16a cannot be disappeared through the PCB carrying portion 111a, a double heat accumulation caused by the power module 16a and the LED chips 14a is therefore occurred on the PCB carrying portion 111a, such that the lifetime of the conventional LED lighting tube 1a does be largely shortened because the conventional LED lighting tube 1a always works under high temperature.

(2) Moreover, for the conventional LED lighting tube 1a, a plurality of electrical wires are necessary to make the power module 16a electrically connect to the PCB 13a and the two end caps 15a; however, using the electrical wires to make the power module 16a electrically connect to the PCB 13a and the two end caps 15a would not only cause the product assembly be difficult but also the increase of product cost.

In view of both the aforesaid two LED lighting tube having drawbacks in product assembly or installation, the manufactures further develop and propose an improved LED lighting tube. Please refer to FIG. 3, which illustrates a stereo view of an improved LED lighting tube. As shown in FIG. 3, the improved LED lighting tube 1b consists of: a tube 11b, a PCB 12b, a plurality of LED chips 16b, and two end caps 13b, wherein the LED chips 16b are disposed on the PCB 12b, and the PCB 12b is accommodated by the tube 11b. In addition, the two end caps 13b are connected to the two openings of the tube 11b, respectively.

In the improved LED lighting tube 1b, each of the end caps 13b are provided with one power module 14b and one terminal module 15b, wherein the power modules 14b are electrically connected to the PCB 12b.

Although the improved LED lighting tube 1b has overcame the drawbacks of the aforesaid two LED lighting tubes, the improved LED lighting tube 1b still show the shortcomings. As shown in FIG. 3, because the power module 14b is connected between end cap 13b and terminal module 15b by way of welding process, the welding process cause the production difficulty and manufacturing cost be increased.

Accordingly, in view of the conventional LED lighting tube include many shortcomings and drawbacks, the inventor of the present application has made great efforts to make inventive research thereon and eventually provided an LED fluorescent tube.

### SUMMARY OF THE INVENTION

The primary objective of the present invention is to provide an LED fluorescent tube. In the LED fluorescent tube, at least one flexible PCB is particularly used for carrying the LED driving unit, wherein the flexible PCB can be accommodated in end caps of the LED fluorescent tube by a bend form. Thus, because the size of the end caps is minimized due to such arrangement, the illumination range of the LED fluorescent tube is therefore increased. Moreover, by the use of the flexible PCB, the inner structure of the end cap does be simplified, so as to make the production difficulty and manufacturing cost of the LED fluorescent tube be largely reduced.

Accordingly, in order to achieve the primary objective of the present invention, the inventor of the present invention provides an LED fluorescent tube, comprising:
a tube having two tube openings;
a main body disposed in the tube;
an LED lighting module, disposed on the main body, and having a first PCB provided with a plurality of LED chips thereon;
two end caps, connected to the two tube openings of the tube, respectively; moreover, each of the end caps have two electrical terminals;
a driving module, comprising two circuit units respectively accommodated by the two end caps, wherein each the circuit unit is constituted by a second PCB, an electrical connector, and a plurality of circuit components;
wherein the circuit components are welded on the second PCB and electrically connected to the two electrical terminals, and the electrical connector being connected between the first PCB and the second PCB.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a stereo view of a traditional LED lighting tube;

FIG. 2 shows an exploded view of a conventional LED lighting tube;

FIG. 3 shows a stereo view of an improved LED lighting tube;

FIG. 4 shows a stereo view of an LED fluorescent tube according to the present invention;

FIG. 5 shows an exploded view of the LED fluorescent tube according to the present invention;

FIG. 6 shows an assembly view of a portion of elements and components of the LED fluorescent tube;

FIG. 7 shows an exploded view of the elements and components of the LED fluorescent tube;

FIG. 8 shows an exploded view of an LED lighting module in the LED fluorescent tube;

FIG. 9 shows a stereo view of one tube opening of a tube in the LED fluorescent tube;

FIG. 10 shows a stereo view of one end cap in the LED fluorescent tube; and

FIG. 11 shows another assembling embodiment for the tube and the end caps.

### DETAILED DESCRIPTION OF THE PREFERRED EMBODIMENTS

To more clearly describe an LED fluorescent tube according to the present invention, embodiments of the present invention will be described in detail with reference to the attached drawings hereinafter.

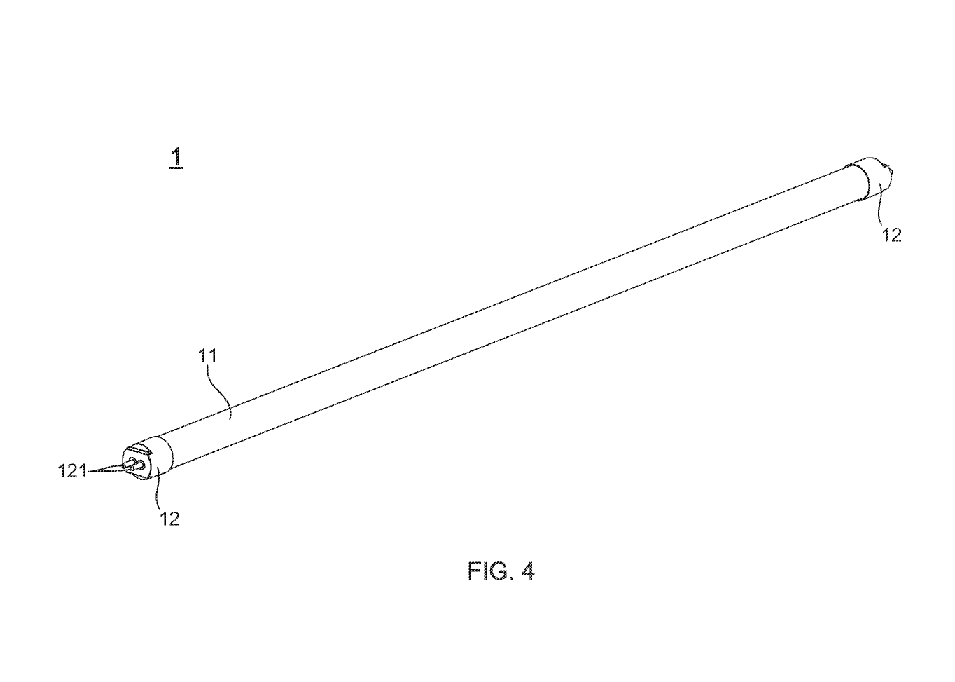

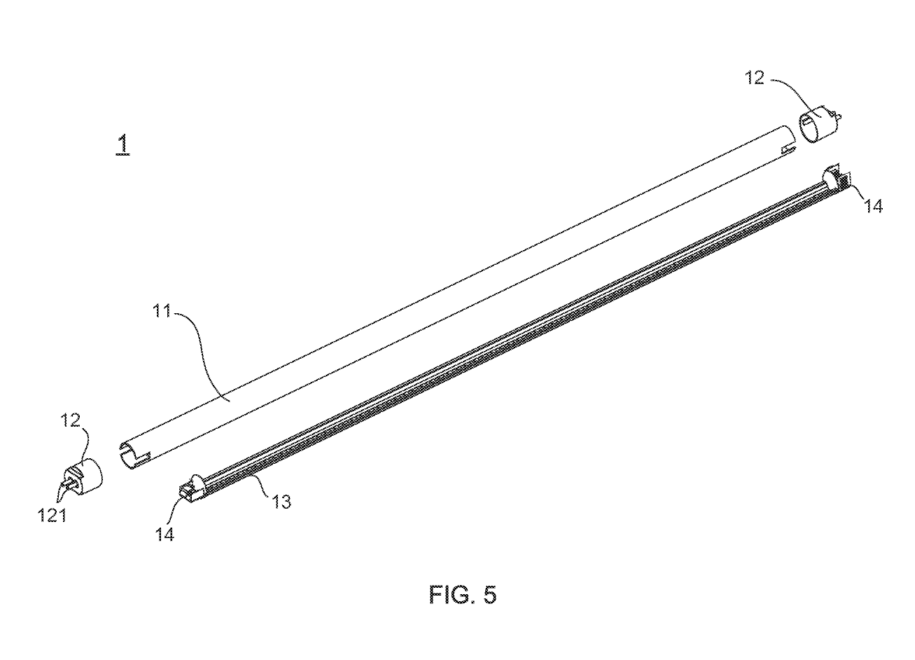

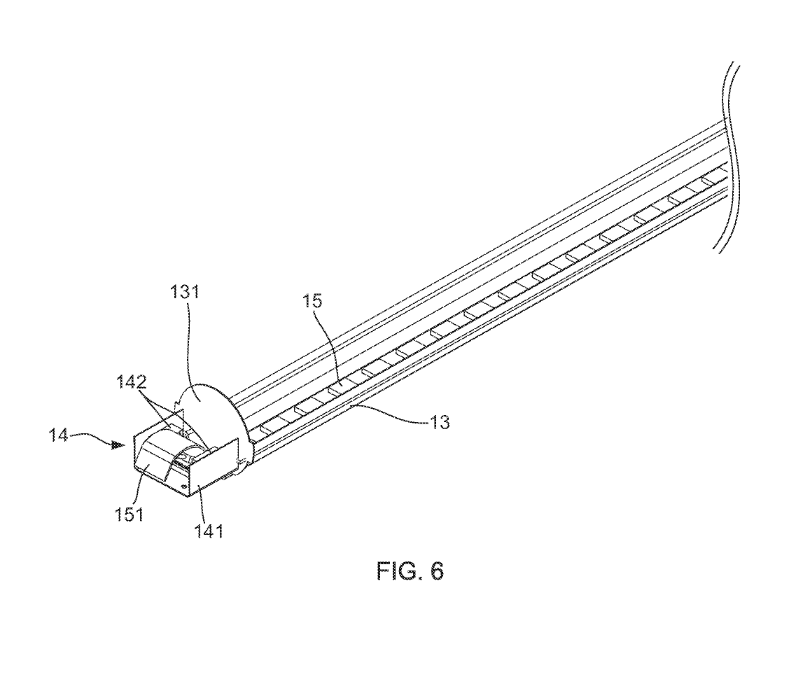

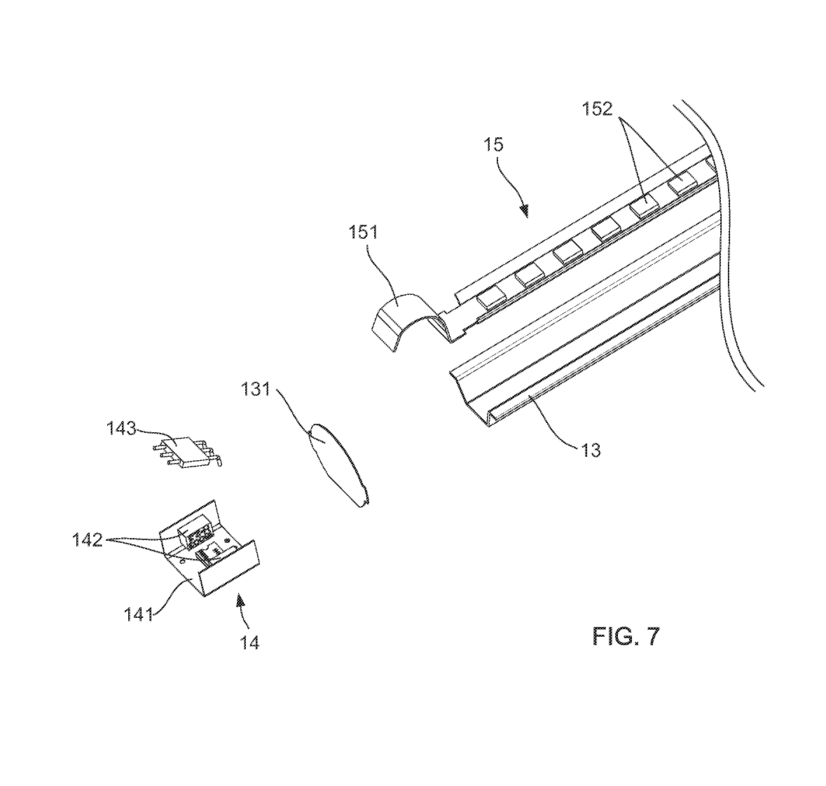

Please referring to FIG. 4 and FIG. 5, where a stereo view and an exploded view of an LED fluorescent tube according to the present invention have been provided. Moreover, an assembly view and an exploded view of a portion of elements and components of the LED fluorescent tube have been shown by FIG. 6 and FIG. 7. As shown in FIG. 4-FIG. 7, the LED fluorescent tube 1 proposed by the present invention consists of: a tube 11 having two tube openings, a main body 13, an LED lighting module 15, two end caps 12, and a driving module. The main body 13 is disposed in the tube 11, and the LED lighting module 15 is disposed on the main body 13. In addition, the two end caps 12 are respectively connected to the two tube openings of the tube 11. Particularly, the driving module includes two circuit units 14 respectively accommodated by the two end caps 12.

In the structure design of the LED fluorescent tube 1, the LED lighting module 15 has a first PCB 151 provided with a plurality of LED chips 152 thereon, and each the circuit unit 14 is constituted by a second PCB 141, an electrical connector 143, and a plurality of circuit components 142. Moreover, the circuit components 142 of the circuit unit 14 are welded on the second PCB 141 and electrically connected to two electrical terminals 121 of the corresponding end cap 12.

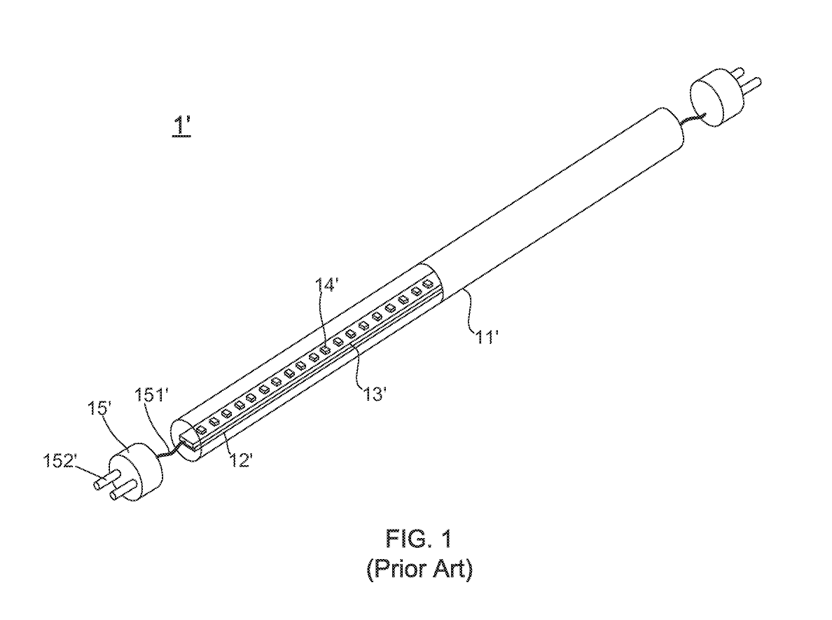

Differing from the conventional technology using the electrical wires 151′ to electrically connect the PCB 13′ with the electrical terminals 152′ of the en caps 15′ (as shown in FIG. 1), in the LED fluorescent tube 1 proposed by the present invention, the circuit components 14 of the driving module are disposed on the second PCB 141 and electrically connected to the electrical terminals 121 of the end caps 12. Therefore, because the second PCB 141 is made of flexible material, the two second PCBs 141 are accommodated in the end caps 12 by a bend form, such that the size of the end caps 12 can be largely minimized due to such arrangement, and the illumination range of the LED fluorescent tube 1 is therefore increased. Moreover, by the use of the second PCBs 141, the structure and the constitution of the driving module disposed in the end cap 12 does be simplified, such that the production difficulty and manufacturing cost of the LED fluorescent tube 1 are hence largely reduced. Herein, it needs to further explain that, the second PCB 141 can also be made of a flexible material and a solid material. The reason is that a portion of the circuit components must be welded on one solid PCB.

In addition, two reflective back plates 131 are disposed on two ends of the main body 13, used for separating the end caps 12 and the LED chips 152 accommodated in the tube 11. By such design, when the LED chips 152 emit light, the reflective back plates 131 are able to prevent the emitted light from entering the internal of end caps 12. Moreover, when the emitted light radiate toward the reflective back plates 131, the light would be reflected back to the internal of the tube 11 by the reflective back plates 131, so as to increase the illumination efficiency of the LED fluorescent tube 1.

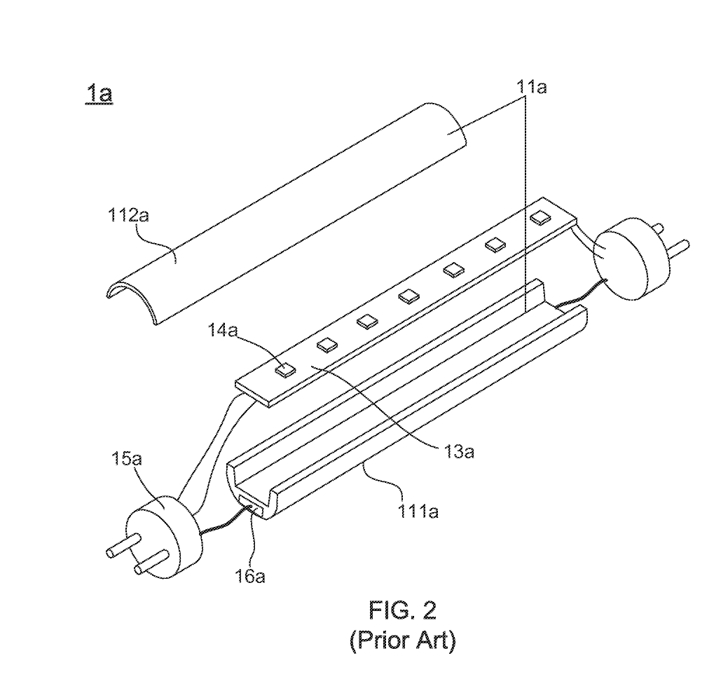

Differing from conventional technology using a plurality of electrical wires to make the power module 16a electrically connect to the PCB 13a and the two end caps 15a (as shown in FIG. 2), in the LED fluorescent tube 1, the electrical connector 143 of the circuit unit 14 is connected between the first PCB 151 and the second PCB 141, so as to make the first PCB 151 electrically connect with the electrical terminals 121 of the end cap 12. By such design, the structure and the constitution of the driving module disposed in the end cap 12 does be simplified, such that the production difficulty and manufacturing cost of the LED fluorescent tube 1 are hence largely reduced.

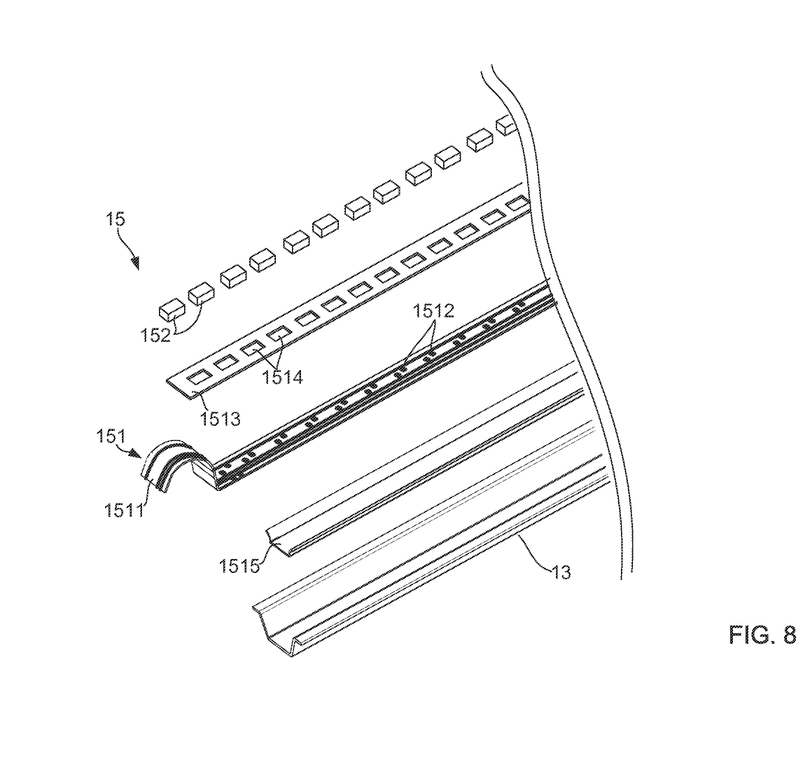

Please continuously refer to FIG. 8, which illustrates an exploded view of the LED lighting module 15. As FIG. 7 and FIG. 8 show, the first PCB 151 is made of a flexible material and consists of: a substrate 1515, a copper circuit layer 1511 and an electric-insulating layer 1513, wherein the substrate 1515 is disposed on the main body 13. Moreover, the copper circuit layer 1511 is formed on the substrate 151 and provided with a plurality of welding pads 1512, and the electric-insulating layer 1513 is covered on the copper circuit layer 1511. Particularly, the electric-insulating layer 1513 is formed with a plurality of welding openings 1514 thereon for making the welding pads 1512 expose out.

Furthermore, in the LED fluorescent tube 1, the LED chips 152 are electrically connected to the welding pads 1512 via the welding openings 1514, and the driving module is electrically connected to the LED chips 152 through the first PCB 151. Herein, it needs to further explain that, the substrate 1515 can be fabricated by using the manufacturing material of Aluminum, polypropylene (PP), polyamide (nylon), polyethylene (PE), polycarbonate (PC), or polyethylene terephthalate (PET).

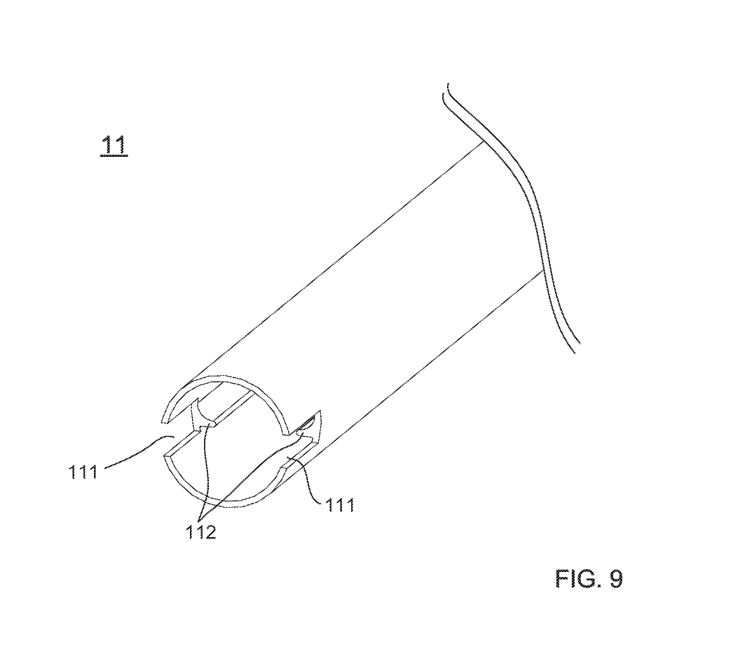

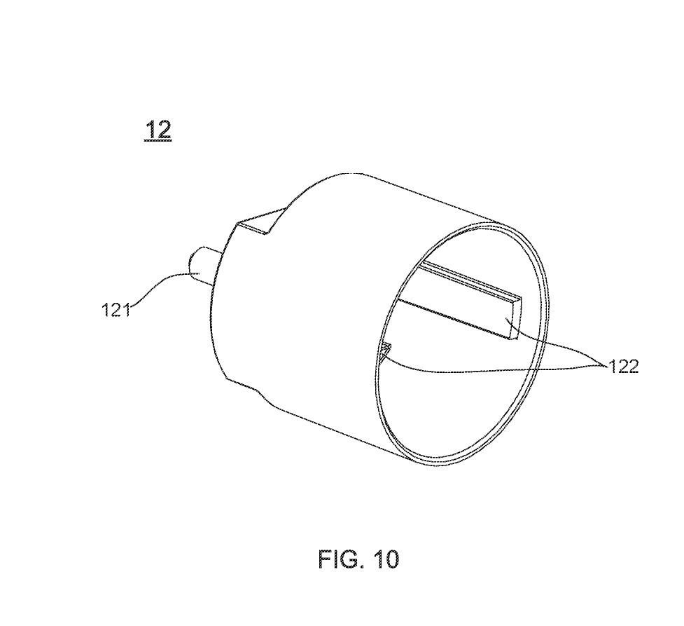

With reference to FIG. 9, which illustrates a stereo view of the tube opening of the tube 11; moreover, please simultaneously refer to FIG. 10, which illustrates a stereo view of the end cap 12. As FIG. 5, FIG. 9 and FIG. 10, each of the tube openings are provided with a positioning notch 111, and each of the end caps 12 are formed with a positioning block 122 therein; therefore, the positioning block 122 would correspondingly embedded into the positioning notch 111 when the end cap 12 is connected to the tube opening. Such design for the assembling elements facilitates the assembly between the end caps 12 and the tube openings of the tube 11 be more easy.

In addition, as FIG. 9 show, there has two positioning protrusions 112 formed on the inner wall of the tube 11 parallel to each other, used for positioning and fixing the main body 13 in the tube 11. Moreover, the main body 13 is made of metal, and both the inner surface and the outer surface of the main body 13 are provided with a white coating.

Herein, it needs further explain that, the tube 11 can be a transparent tube or a tube with matte surface fabricated by using glass as manufacturing material. Moreover, when processing the glass to the tube 11, an optical diffusion material can be doped into the glass-made tube 11 for enhancing the light scattering ability of the tube 11. However, except for the glass, plastic can also be used as the manufacturing material of the tube 11. In addition, the LED chips 152 used in the LED fluorescent tube 1 can be fabricated by way of Chip-on-Board (COB) or Flip-Chip (F/C) technology.

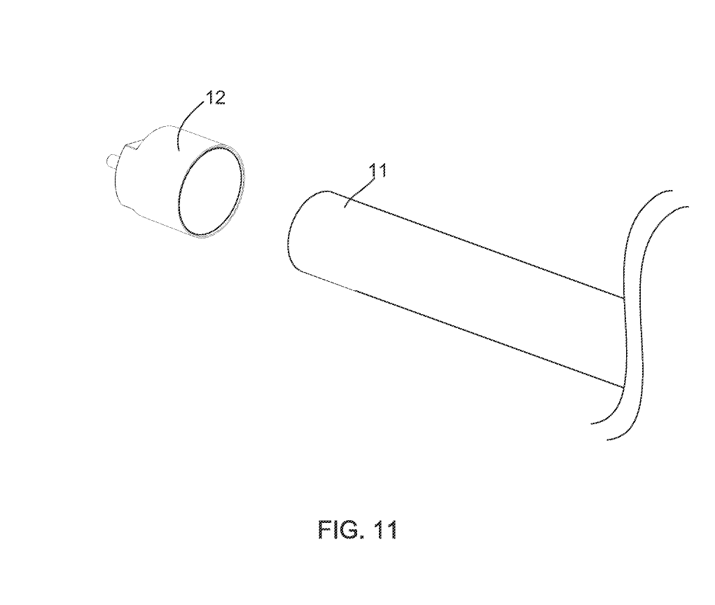

Please further refer to FIG. 11, where another assembling embodiment for the tube 11 and the end caps 12 is provided. Differing from the assembling elements (i.e., the positioning block 122 and the positioning notch 111) shown in FIG. 9 and FIG. 10, the tube 11 and the end cap 12 shown in FIG. 11 is assembled by using ultrasonic welding process.

Therefore, through above descriptions, the LED fluorescent tube 1 provided by the present invention have been introduced completely and clearly; in summary, the present invention includes the advantages of:

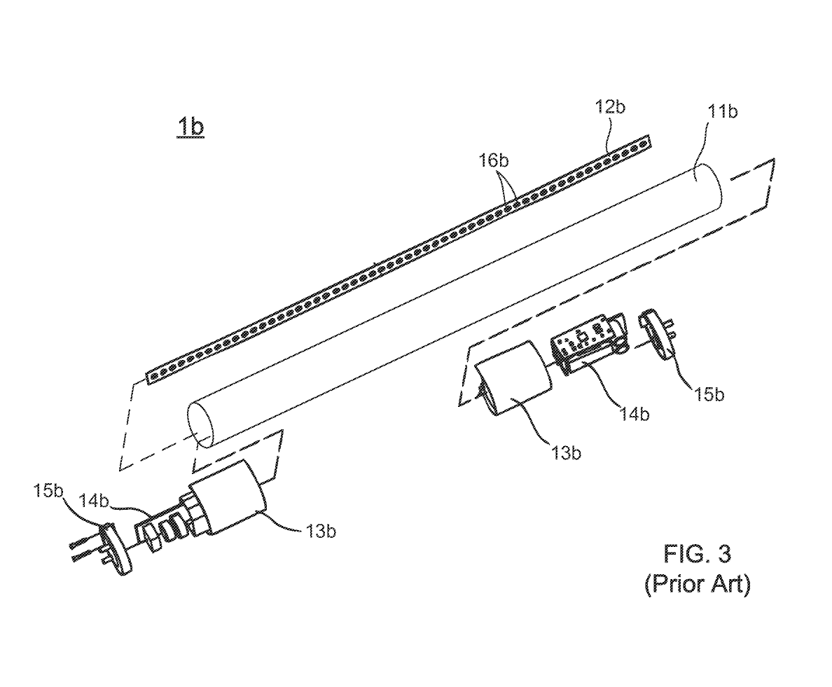

(1) Differing from the conventional LED light tubes (shown in FIG. 1-FIG. 3), in the LED fluorescent tube 1 proposed by the present invention, the circuit components 14 of the driving module are disposed on the second PCB 141 and electrically connected to the electrical terminals 121 of the end caps 12. Therefore, because the two second PCBs 141 are accommodated in the end caps 12 by a bend form, the size of the end caps 12 can be largely minimized due to such arrangement, and the illumination range of the LED fluorescent tube 1 is therefore increased. Moreover, by the use of the second PCBs 141, the structure and the constitution of the driving module disposed in the end cap 12 does be simplified, such that the production difficulty and manufacturing cost of the LED fluorescent tube 1 are hence largely reduced.

The above description is made on embodiments of the present invention. However, the embodiments are not intended to limit scope of the present invention, and all equivalent implementations or alterations within the spirit of the present invention still fall within the scope of the present invention.

What is claimed is:

1. An LED fluorescent tube, comprising:
a tube having two tube openings;
a main body, being disposed in the tube;
an LED lighting module, being disposed on the main body, and having a first PCB provided with a plurality of LED chips thereon;
two end caps, being respectively connected to the two tube openings of the tube, moreover, each of the end caps having two electrical terminals;
a driving module, comprising two circuit units respectively accommodated by the two end caps, wherein each the circuit unit is constituted by a second PCB, an electrical connector, and a plurality of circuit components;
wherein the circuit components are welded on the second PCB and electrically connected to the two electrical terminals, and the electrical connector being connected between the first PCB and the second PCB;
wherein the two second PCB are accommodated in the two end caps 12 by a bend form, respectively.

2. The LED fluorescent tube of claim 1, wherein each of the tube openings are provided with a positioning notch, and each of the end caps being formed with a positioning block therein; therefore, the positioning block would correspondingly embedded into the positioning notch when the end cap is connected to the tube opening.

3. The LED fluorescent tube of claim 1, wherein two positioning protrusions are formed on the inner wall of the tube parallel to each other, used for positioning and fixing the main body in the tube.

4. The LED fluorescent tube of claim 1, wherein two reflective back plates are connected to the two ends of the main body, used for separating the end caps and the LED chips accommodated in the tube.

5. The LED fluorescent tube of claim 1, wherein the first PCB comprises:
a substrate, being made of a flexible material, and disposed on the main body;
a copper circuit layer, being formed on the substrate and provided with a plurality of welding pads; and
an electric-insulating layer, being covered on the copper circuit layer, moreover, a plurality of welding openings being formed on the electric-insulating layer for making the welding pads be exposed out;
wherein the electric-insulating layer is disposed between the LED chips and the copper circuit layer, and the LED chips are electrically connected to the welding pads via the welding openings;
wherein the driving module is electrically connected to the LED chips through the first PCB.

6. The LED fluorescent tube of claim 1, wherein the manufacturing material of the tube is selected from group consisting of: glass, plastic, and the combination of the aforesaid two materials.

7. The LED fluorescent tube of claim 1, wherein the main body is made of metal, and both the inner surface and the outer surface of the main body are provided with a white coating.

8. The LED fluorescent tube of claim 1, wherein the end caps are respectively assembled with the two tube openings of the tube by using ultrasonic welding process.

9. The LED fluorescent tube of claim 5, wherein the manufacturing material of the substrate is selected from group consisting of: Aluminum, polypropylene (PP), polyamide (nylon), polyethylene (PE), polycarbonate (PC), and polyethylene terephthalate (PET).
